(19) United States
(12) Patent Application Publication
(10) Pub. No.: US 2011/0209831 A1
(43) Pub. Date: Sep. 1, 2011

(54) HIGH-SPEED LABEL TRANSFER/STICKING SYSTEM

(76) Inventors: Takashi SEKIMOTO, Osaka (JP); Motokazu Motai, Kanagawa (JP); Shinichi KASHIWAGI, Tokyo (JP); Yoshiaki ITOH, Tokyo (JP)

(21) Appl. No.: 13/031,901

(22) Filed: Feb. 22, 2011

(30) Foreign Application Priority Data
Feb. 26, 2010 (JP) 2010-41481
Aug. 30, 2010 (JP) 2010-192053

(51) Int. Cl. B32B 41/00

(52) U.S. Cl. 156/361

(57) ABSTRACT

There is provided a high-speed label transfer/sticking system including a label printer (1) to deliver a printed and separated label, a sensor (15) to detect the delivered label, a label transfer unit (6) formed from an endless adsorption belt disposed near the downstream side of the label printer (1), a work sensor (16) to detect the position to which a work has been carried, a calculating device (31) which, supplied with a detection signal from the work sensor (16), calculates a position of the work, a forward end position of the label and a target labeling position, and a controller (30) to control, based on information calculated by the calculating unit (31), the speed of the label transfer unit variably correspondingly to the work transfer speed of a work conveyor (17). Being freely installable to a well-known label printer, the label transfer/sticking system transfers a label having information printed thereon by the label printer and which has been separated from a carrying base at a high speed to a labeling position and sticks the label to a work.

### TECHNICAL FIELD

The present invention relates to a high-speed label transfer/sticking system that transfers each separated one of labels having information printed thereon by a label printer to a labeling position at a high speed synchronously with an object transferred separately from the label and to which the label is to be stuck and sticks the label to the object

### BACKGROUND ART

There are known label transfer/sticking system adapted to print required information on adhesive labels by a label printer just before sticking to an object to which the label is to be stuck (will be referred to as “work” hereunder), then separate each label from a carrying base, transfer it to a labeling position and stick it to the work there. For example, there is disclosed in the Japanese Published Unexamined Patent Application No. H6-239325 a technique of transferring, to a labeling roller, two parallel labels provisionally stuck to a release paper (carrying base) while keeping the labels adsorbed on an adsorption feed belt. Also, the Japanese Published Unexamined Patent Application No. 2009-62087 (previously proposed by the Applicant) discloses a technique of separating, from a carrying base, each of labels having information printed thereon by a printer, putting it onto a plurality of endless rubber belts and transferring it horizontally to a labeling position.

### DISCLOSURE OF THE INVENTION

To meet the recent demand for a higher efficiency of labeling, however, the conventional label printer designed to print required information on a label just before labeling should be used in combination with a device designed to transfer each separated one of labels having the information printed thereon by a label printer by a label transfer unit capable of transferring the label at a speed corresponding to the transfer speed of a conveyor to carry a work and stick the label to the work efficiently without bringing the label transfer unit and work conveyor down.

It is therefore desirable to overcome the above-mentioned drawbacks of the related art by providing a high-speed label transfer/sticking system capable of detecting a work transferred by a work conveyor, then printing information such as a bar code, date, etc. different from one work to another on each label by a label printer, transferring each separated one of the labels by a label transfer unit, of which the carrying speed can be variably controlled correspondingly to the transfer speed of the work conveyor, while holding the label adsorbed on the label transfer unit, and sticking the label to the work precisely in a labeling position efficiently with the label transfer unit and work conveyor not brought down.

According to an embodiment of the present invention, there is provided a high-speed label transfer/sticking system including a label printer to deliver a printed and separated label, a sensor to detect the delivered label, a label transfer unit formed from an endless adsorption belt disposed near the downstream side of the label printer, a work sensor to detect the position to which a work has been carried, a calculating device which, supplied with a detection signal from the work sensor, calculates a position of the work, a forward end position of the label and a target labeling position, and a controller to control, based on the information calculated by the calculating unit, the speed of the label transfer unit variably correspondingly to the work transfer speed of a work conveyor.

According to another embodiment of the present invention, the adsorption belt of the label transfer unit is formed from two adsorption belts, and a label presser is provided at the forward of the label transfer unit and between the two adsorption belts to press the label to the work.

According to still another embodiment of the present invention, the label presser includes an abutment portion that is biased by a biasing unit outwardly from the forward end of the label transfer unit, thus put into abutment with the work and forced back toward the forward end of the label transfer unit against the force of the biasing portion correspondingly to the thickness of the work, the abutment of the abutment portion with the work causing the label to be pressed to the work.

The label transfer/sticking system according to the present invention is applicable to a well-known label printer incorporating a printer and a peeling block which separates each of labels without any modification. According to the present invention, the label is transferred on the endless adsorption belt under a negative pressure, and the label-transferring adsorption belt is variably controllable in driving speed correspondingly to the speed of a work being transferred separately on a work conveyor for synchronization with the work carrying speed at the time of labeling. Thus, the present invention allows precise labeling irrespectively of the work carrying speed.

Further, since each of labels having information printed thereon by the label printer can be transferred at a high speed to the labeling position and stuck to a work, information printing by the label printer can be retried even if any label cannot be successfully stuck. Thus, no label goes to waste because no other printed label will stand by. Accordingly, each of labels having printed thereon information different from one work to another can be stuck to a work at a high speed.

### BRIEF DESCRIPTION OF THE DRAWINGS

FIG. 1 is a schematic side elevation of the overall structure of a first embodiment of the high-speed label transfer/sticking system according to the present invention.

FIG. 2 is a side elevation of a label transfer unit included in the apparatus in FIG. 1.

FIG. 3 shows, in the form of a block diagram, the internal structure of the controller in FIG. 1.

FIG. 4 shows the flow of operations effected in the apparatus.

FIG. 5 explains the process in which a work is detected and then a label is delivered for sticking to the work.

FIG. 6 explains the process in which after the delivery of a label is detected, positions of a work and delivered label are calculated and the label is fed synchronously with the work over the distance along the labeler to the labeling position.

FIG. 7 explains how the work speed and label transfer speed are changed.

FIG. 8 is a schematic side elevation of the overall structure of a high-speed label transfer/sticking system according to a second embodiment of the present invention.

FIG. 9 is schematic plan view of the labeler for transferring a label.

FIG. 10 is a side elevation of the label presser when the labeler is in the stand-by state for labeling.

FIG. 11 is a side elevation of the label presser when the labeler is applying a label to the work.

### DETAILED DESCRIPTION OF THE PRESENT INVENTION

### First Embodiment

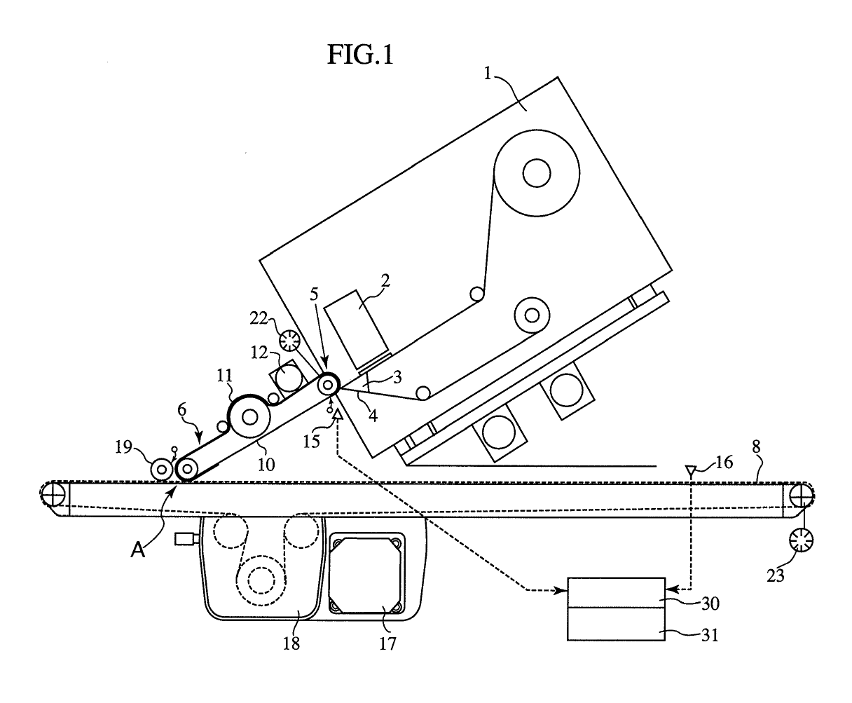

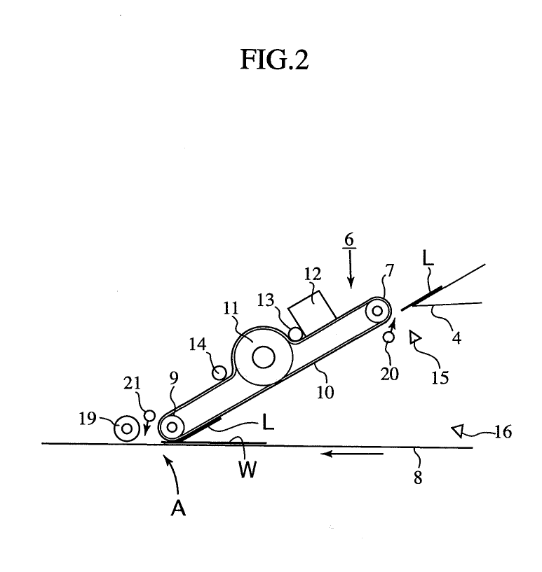

The present invention will be described in detail below concerning the embodiments thereof with reference to the accompanying drawings. FIGS. 1 and 2 schematically show the construction of the high-speed label transfer/sticking system according to the first embodiment of the present invention. In Figures, the reference numeral 1 indicates a well-known label printer. As seen, each label L is fed being carried on a release paper through a printing post 2 to a peeling block 4 provided with a sharp edge 3 at the outlet of the label printer 1. The release paper is folded back by the peeling block 4 and the label L is let out of a label ejector 5. It should be noted that since the construction of the label printer 1 is well-known, it will not be described in detail.

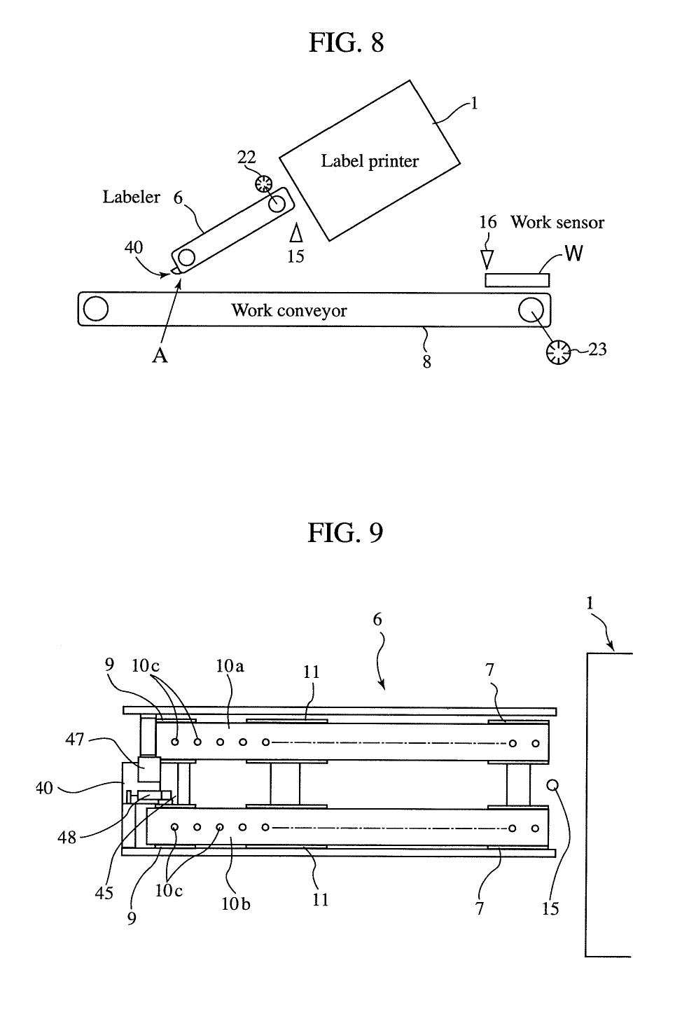

The reference numeral 6 indicates a labeler which transfers a label. As seen, the labeler 6 includes a roller 7 provided near the label printer 1, a roller 9 provided near a work conveyor 8, an endless adsorption belt 10 extended between and around the rollers 7 and 9, and a drive roller 11 which drives the endless belt 10. The reference numeral 12 indicates a drive motor to drive the labeler 6. The adsorption belt 10 is of a flat type and has a plurality of suction holes (best shown with a reference number 10c in FIG. 9) longitudinally formed in the surface thereof at predetermined intervals and through which the label L is adsorbed to the adsorption belt 10 under a negative pressure produced by a blower (not shown). The endless adsorption belt 10 is always applied with the negative pressure. In Figures, the reference numeral 13 indicates a tension roller and 14 indicates a driven roller. The tension roller 13 and driven roller 14 work together to tense the adsorption belt 10.

A sensor 15 is provided below the label ejector 5 of the label printer 1 to detect a label L having been delivered. Detecting the rear end of the delivered label L, the sensor 15 sends a delivered-label detection signal to a controller 30. The controller 30 includes a calculation device 31. Also a work sensor 16 is provided in an appropriate place along the path of the work conveyor 8 to detect a position to which a work W has been transferred and send a detected position of the work W to the controller 30. Also, a drive motor 17 and conveyor driving unit 18 are provided to drive the work conveyor 8. Near the front end of the labeler 6 there is also provided a secondary pressing roller 19 to support a label L being stuck to a work W.

There are also provided air blow nozzles 20 and 21. The first air blow nozzle 20 is located below the label ejector 5 to give air blow to an ejected label L from below for smooth transition of the label L to the labeler 6. The second air blow nozzle 21 is located near a labeling position to blow air obliquely from above to the label L having been transferred by the labeler 6 for transition of the label L to the surface of the work W. At this time, the label L is in a position under the roller 9 where the suction holes in the adsorption belt 10 are closed by the roller 9 and thus no more negative pressure will be applied to the label L through the suction holes. Thus, the label L will be released from the belt 10 and transferred to the surface of the work W under the effect of the air blow from the air blow nozzle 21.

Further, encoders 22 and 23 are provided in the apparatus. However it should be noted that sensors to detect light pulses etc. are not illustrated herein. The encoder 22 is used to detect the running direction of the drive motor 12 which drives the adsorption belt 10, and the moving distance and rotation speed of the belt 10. The encoder 23 is used to detect the running direction of the drive motor 17 which drives the work conveyor 8, and the moving distance and speed of the work.

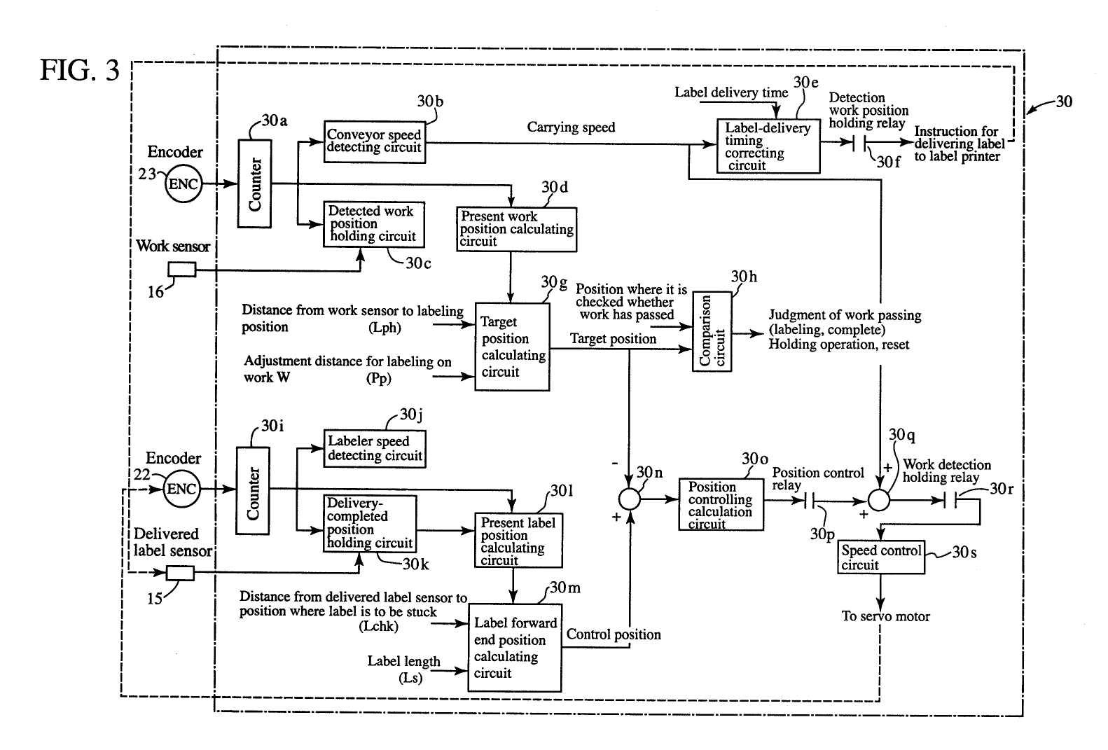

The aforementioned controller 30 is constructed as shown in FIG. 3 for example. The controller 30 includes a counter 30a to count pulses from the encoder 23, a circuit 30b to detect the conveyor speed, a circuit 30c to hold a detected position of the work, and a calculating circuit 30d to determine a present position of the work. The controller 30 further includes a circuit 30e to correct the timing of label delivery according to a preset time of label delivery, and a work-detection holding relay 30f to supply an instruction for delivery of a label to the label printer 1 after the work is carried.

It should be noted that the result of detection from the conveyor speed detection circuit 30b is used to synchronize the speed at which the labeler 6 transfers the label L with the conveyor speed. The detection result from the conveyor speed detection circuit 30b is also used to adjust the timing when an instruction for delivering a label is supplied. The detected work position holding circuit 30c holds a value counted by the counter 30a at the moment when a work W is detected by the work sensor 16 until the work W passes by the labeling position A. The present work position calculating circuit 30d determines the moving distance of the work W by calculating a difference between the value counted by the counter 30a at the moment when the work sensor 16 has detected the work W and a present count in the counter 30a.

The controller 30 includes also a target position calculating circuit 30g to determine a target position where a label L is to be stuck on the basis of a distance (Lph) from the work sensor 16 to the labeling position on the work W and a adjustment distance (Pp) for labeling on the work W, and a comparison circuit 30h which makes comparison between the target position and a position at which passage of the work W has been checked to judge whether the work W has passed or not.

The controller 30 further includes a counter 30i to count pulses from the encoder 22, a circuit 30j to detect the belt speed of the labeler 6, a circuit 30k to hold a position where a label L has been delivered, and a calculation circuit 30l to determine a present position of the label L. Moreover, the controller 30 includes a calculation circuit 30m to determine the forward end position of the label L on the basis of a distance (Lchk) from the delivered label sensor 15 to a position where the label L is to be stuck and the length of the label L (Ls), and a subtractor 30n to subtract the target position from the forward end position of the label L.

It should be noted that the label delivery-position holding circuit 30k holds a value counted by the counter 30i at the moment when the sensor 15 detects the rear end of the delivered label L until the work W passes by the labeling position A. The label present position calculation circuit 30l adds the present count in the counter 30i to the value counted by the counter 30i at the moment when the sensor 15 detects the rear end of the delivered label L to determine a moving distance of the label L. For determining the forward end position of the label L, the label forward-end position calculation circuit 30m calculates a difference between the value counted by the counter 30i at the moment when the sensor 15 detects the rear end of the label L and present count in the counter 30i to determine a moving distance of the label L.

The controller 30 further includes a position controlling calculation circuit 30o to determine, based on a value supplied from the subtractor 30n, a value for controlling the forward end position of the label L, a position control relay 30p to provide a value for controlling the forward end position, an adder 30q to add the forward-end position controlling value and above-mentioned conveyor speed, and a work detecting/holding relay 30r to hold the position of a work W based on the output from the adder 30q and provide a speed command through a speed control circuit 30s.

It should be noted that the position controlling calculation circuit 30o controls the carrying speed of the label L so that the label L and work W coincide in relative position with each other. The speed control circuit 30s provides such control that in case the control value for coincidence in relative position between the label L and work W exceeds a predetermined upper or lower limit, it will fall within the range between these limits.

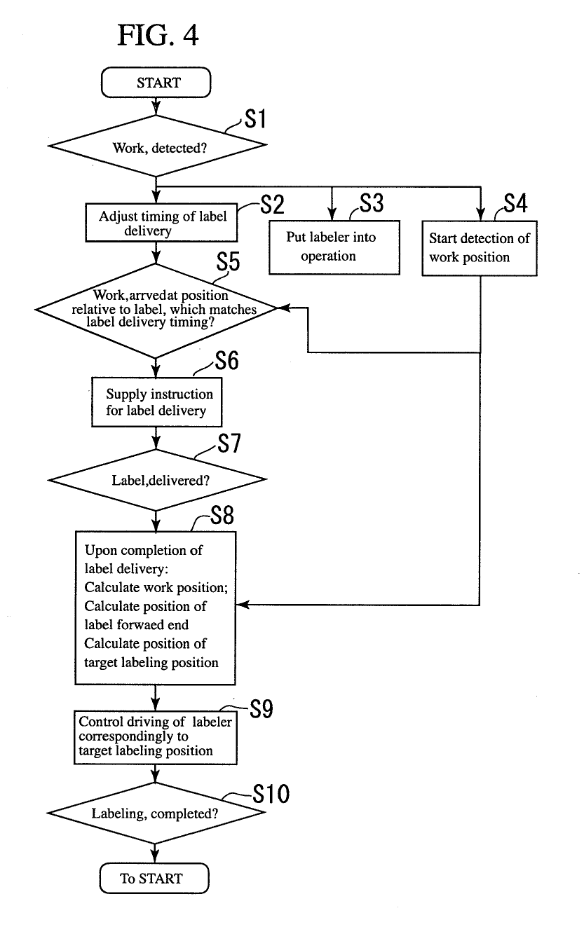

The high-speed label transfer/sticking system according to the present invention operates as will be described below with reference to the flow chart shown in FIG. 4.

The label printer 1 itself has a well-known construction, and so its operation will not be described in detail herein. When the work sensor 16 detects a work W to be carried on the work conveyor 8 (in step S1), timing of delivering a label L is adjusted (in step S2). This label-delivery timing is adjusted such that Ld is equal to Wd+Pp even if the work W is carried at any other speed as will be explained with reference to FIG. 6 later.

Note that the above value “Ld” is a distance from the forward end of the label L to the labeling position A, “Wd” is a distance from the forward end of the work W to the labeling position A and “Pp” is a distance for adjusting the labeling position in relation to the work W.

The adjustment of label-delivery timing will be explained in further detail below. A time length Timm for adjusting the label-delivery timing is determined by calculating Timm=(Lhigh−Lcur)+Pp.

In the above equation, Lhigh is a calculated moving distance of a work for a label being delivered at a maximum speed and it is determined by calculating Smax×Tprt where Smax is a maximum carrying speed in mm/sec and Tprt is a label delivery time in sec of the label printer 1. Lcur is a calculated moving distance of a work for a label being delivered at an actual speed and is determined by calculating Scur×Tprt where Scur is a carrying speed in mm/sec when the work is detected.

Upon adjustment of label-delivery timing in step S2, the labeler 6 is put into operation in step S3 and position detection of a work is started in step S4. When the work W arrives at a position relative to the label L, which matches the delivery timing of a label L, in step S5, an instruction for delivery of a label L is supplied to the label printer 1 in step S6.

Then the label printer 1 prints a bar code, date and other necessary information onto the label L. It should be noted that after such printing is made on the label L, the release paper is folded back by the sharp edge 3, opposite to the label ejector 5, of the peeling block 4 and one label L is delivered. Thus, labels are delivered one by one.

When a detection signal is supplied from the delivered label sensor 15 provided below the label ejector 5, it is confirmed in step 7 that the label L has been delivered. Then, a target labeling position is calculated based on the position of the work W and forward end position of the label L in step S8. Driving of the adsorption belt 10 of the labeler 6 is controlled correspondingly to the target labeling position in step S9 so as to be synchronous with the transfer speed of the work conveyor 8 in the labeling position A, and labeling onto the work W is thus completed in step S10.

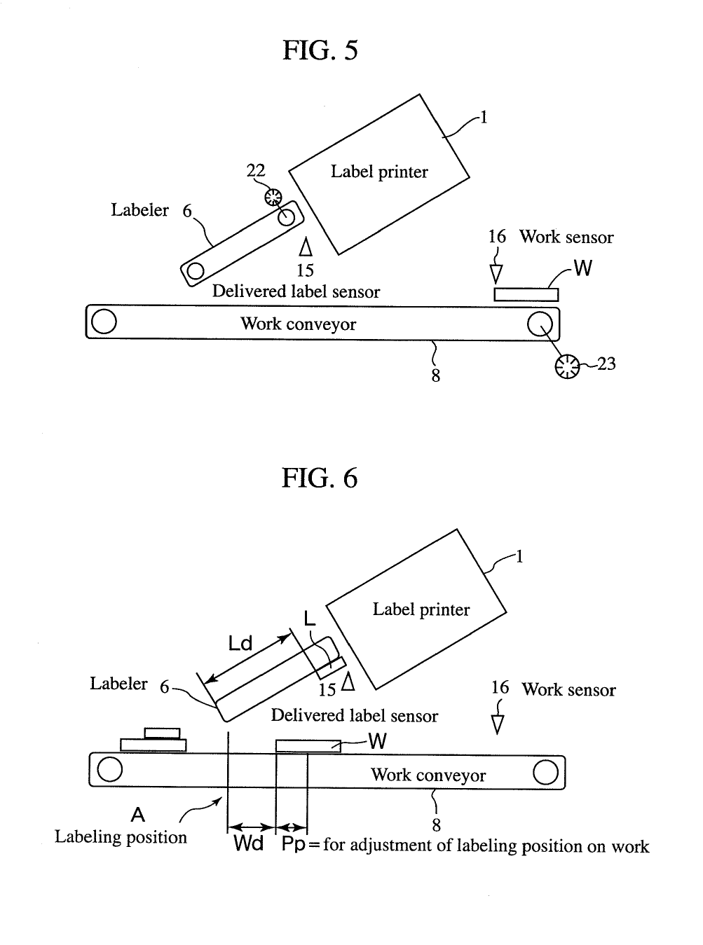

The adsorption belt 10 of the labeler 6 is driven under control as will be explained below with reference to FIGS. 5 and 6. When a work W is detected by the work sensor 16 as shown in FIG. 5, the label printer 1 will print necessary information onto a label L. Then, it will be checked by the delivered label sensor 15 that the label L has been delivered as shown in FIG. 6. At this time, the work W will have been moved to the labeling position A.

It is determined as shown in FIG. 6 whether Wd+Pp<Ld or Wd+Pp>Ld where Wd is a distance between the forward end of the work W and the labeling position A, Pp is a distance for adjusting the labeling position on the work W and Ld is a distance from the forward end of the label L to the labeling position A as having been described in the foregoing.

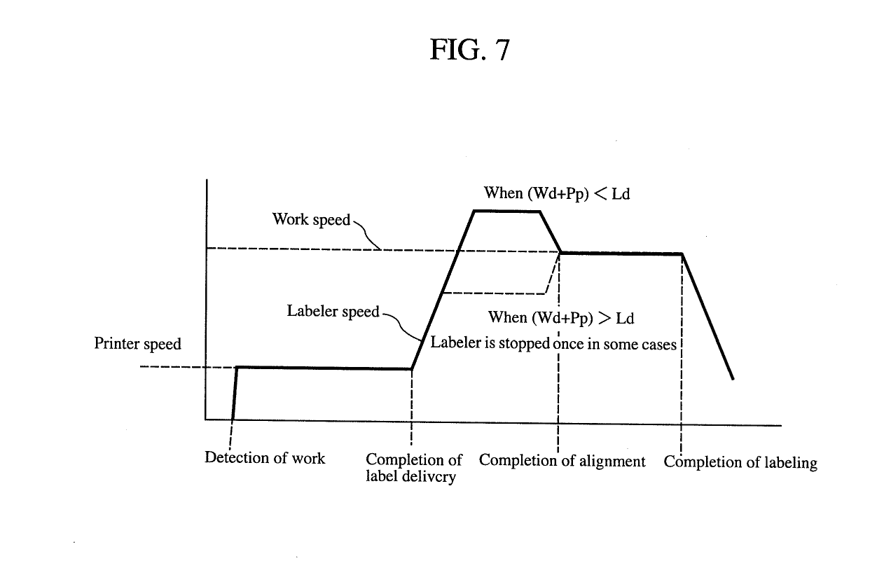

When the delivery of the label L is complete, the labeler 6 is driven as shown in FIG. 7. Namely, in case Wd+Pp<Ld, the labeler 6 is driven once at a faster speed than the carrying speed of the work W. In case Wd+Pp>Ld, the labeler 6 is driven once at a slower speed than the carrying speed of the work W. Thus, the labeler 6 and work conveyor 8 are controlled for the work W and label L to coincide in relative position with each other before labeling. It should be noted that when the label L and work W coincide in relative position with each other, the label and work speeds become equal to each other and controlled for synchronization until the label L is stuck to the work W.

As having been described in the foregoing, in the high-speed label transfer/sticking system according to the first embodiment of the present invention, the controller 30 controls the transfer speed of the label L variably based on each of the position of the work W, forward end position of the label L and target labeling position of the label L so as to match the transfer speed of the work W on the work conveyor 8. Thus, the label L can be stuck precisely irrespectively of the transfer speed of the work W.

### Second Embodiment

FIGS. 8 and 9 schematically illustrate the overall structure of a second embodiment of the present invention which is different in construction from the first embodiment of the label transfer/sticking system shown in FIGS. 1 and 2. In the following description, elements which are the same as those in the first embodiment will be referred to using the same reference numerals having been used in the foregoing description of the first embodiment and will not further be explained.

The second embodiment is different from the high-speed label transfer/sticking system according to the first embodiment shown in FIGS. 1 and 2 in that it further includes a label presser 40 to press a label to the labeling position A at the forward end of the labeler 6. It is also different from the first embodiment shown in FIGS. 1 and 2 in that as will be known from FIG. 9, two adsorption belts 10a and 10b are used instead of the endless adsorption belt 10 shown in FIGS. 1 and 2. The belts 10a and 10b have suction holes 10c formed therein as shown in FIG. 9. The suction holes 10a and 10b are provided to let the label L cling closely to the belts 10a and 10b under the effect of a negative pressure. In other respects, the second embodiment is the same in construction as the first embodiment shown in FIGS. 1 and 2.

As shown in FIGS. 8 and 9 The label presser 40 is provided between the adsorption belts 10a and 10b so as to be protruded and retracted relative to the surface of the work conveyor 8 when the labeler 6 is turned on and off, respectively. Also, the label presser 40 is variable in position correspondingly to the thickness of a work W when the labeler 6 is going to stick a label to the work W. The label presser 40 will be explained in further detail below.

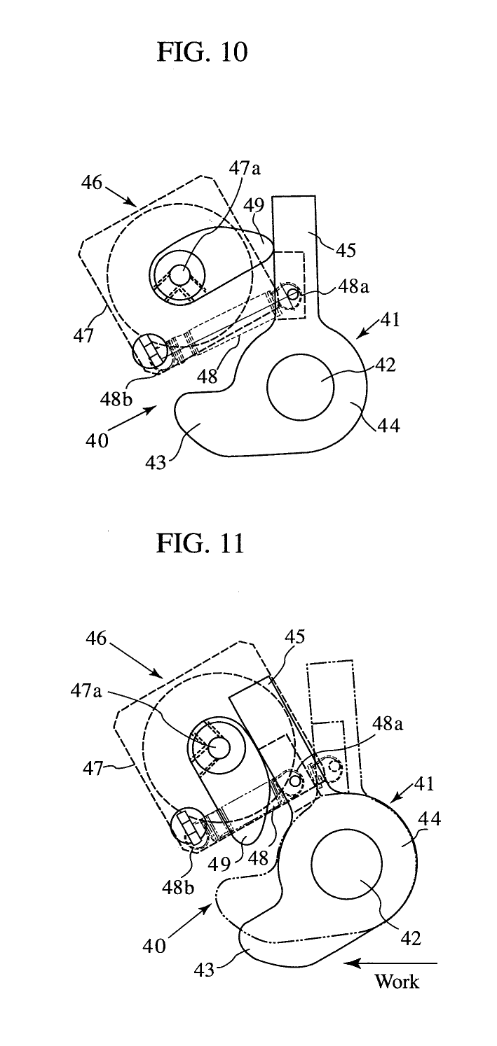

The label presser 40 includes a label pressing member 41 and a pressing-member biasing member 46 as shown in FIGS. 10 and 11. The label pressing member 41 includes a body 44 supported pivotally on a shaft 42 and having an abutment portion 43 formed at a part of the circumference thereof and which is to abut on the work W, and a pressing lever 45 formed integrally with the pivotal body 44 to project upward.

The pressing-member biasing member 46 includes a rotary cylinder 47, a tension spring 48 of which one end 48a is engaged on the pressing lever 45 and the other end 48b is engaged on the rotary cylinder 47, and a cam 49 installed on a rotary shaft 47a.

Owing to this construction, when the labeler 6 is in standby state (out of operation), the cam 49 is driven by the rotary cylinder 47 to pivot upward and press the pressing lever 45 against the force of the tension spring 48 as shown in FIG. 10. At this time, the abutment portion 43 of the label pressing member 41 is pivoted upward (as shown with a two-dot chain line in FIG. 11) and thus drawn back not to protrude from between the adsorption belts 10a and 10b shown in FIG. 9.

When the labeler 6 is put into operation for labeling, the cam 49 is driven by the rotary cylinder 47 to pivot downward and leave the pressing lever 45 as shown in FIG. 11. Thus, the abutment portion 43 of the pressing lever 45 is pulled under the action of the tension spring 48 to pivot downward. In this way, the abutment portion 43 of the label pressing member 41 is forced out from between the adsorption belts 10a and 10b shown in FIG. 9 toward the surface of the work conveyor 8.

As mentioned above, a work W having been carried by the work conveyor 8 to the labeling position A will abut on the abutment portion 43 of the label pressing member 41 and the abutment portion 43 will be forced upward correspondingly to the thickness of the work W against the force of the tension spring 48. Also, the suction holes 10c in the forward end portion of the suction belts 10a and 10b are closed by the roller 9 and hence no more negative pressure is applied to the label L through the suction holes 10c. Thus, the label L having been adsorbed to the adsorption belts 10a and 10b under the negative pressure is released from the belts 10a and 10b, pressed to the work W by the abutment portion 43 of the label pressing member 41 and further pressed to the work W by the secondary pressing roller 19, whereby the label L is positively stuck to the work W.

In the second embodiment, the abutment portion 43 of the label presser 40 is biased by the tension spring 48 in a direction in which it is forced out from the forward end of the labeler 6. When the abutment portion 43 abuts on the work W, it is forced back toward the forward end of the labeler 6 against the force of the tension spring 48 correspondingly to the thickness of the work W. Namely, as the abutment portion 43 abuts on the work W, the label L is pressed to the work W. Even if the works W are different in thickness from one another, the label L can be positively stuck to each of such works W.

Since the high-speed label transfer/sticking system according to the present invention can be arbitrarily used in combination with an existing label printer, it can be freely installed in the labeling process in existing factories or the like and applied widely.

1. A high-speed label transfer/sticking system including:
a label printer to deliver a printed and separated label;
a sensor to detect the delivered label;
a label transferring means formed from an endless adsorption belt disposed near the downstream side of the label printer;
a work sensor to detect the position to which a work has been carried;
a calculating means which, supplied with a detection signal from the work sensor, calculates a position of the work, a forward end position of the label and a target labeling position; and
a controller to control, based on the information calculated by the calculating means, the speed of the label transferring means variably correspondingly to the work transfer speed of a work conveyor.

2. The high-speed label transfer/sticking system according to claim 1, wherein the adsorption belt of the label transferring means is formed from two adsorption belts, and a label pressing means is provided at the forward of the label transferring means and between the two adsorption belts to press the label to the work.

3. The high-speed label transfer/sticking system according to claim 2, wherein the label pressing means includes an abutment portion that is biased by a biasing means outwardly from the forward end of the label transferring means, thus put into abutment with the work and forced back toward the forward end of the label transferring means against the force of the biasing portion correspondingly to the thickness of the work, the abutment of the abutment portion with the work causing the label to be pressed to the work.
